(19) United States
(12) Patent Application Publication
(10) Pub. No.: US 2019/0004841 A1
(43) Pub. Date: Jan. 3, 2019

(54) Memory Sharing For Virtual Machines

(71) Applicant: Microsoft Technology Licensing, LLC, Redmond, WA (US)

(72) Inventor: John A. Starks, Seattle, WA (US)

(73) Assignee: Microsoft Technology Licensing, LLC, Redmond, WA (US)

(21) Appl. No.: 15/638,858

(22) Filed: Jun. 30, 2017

(51) Int. Cl. G06F 9/455; G06F 9/50; G06F 3/06

(52) U.S. Cl. CPC G06F 9/45558; G06F 12/1027; G06F 3/0647; G06F 9/5077

(57) ABSTRACT

A device runs multiple virtual machines, each having an associated virtual machine memory in which programs can be loaded and run. Situations can arise in which multiple virtual machines desire access to the same portion of the same file. For example, each virtual machine may be running the same word processing program and thus request loading of the same executable file. A virtual machine manager monitors requests from the virtual machines to load portions of files that can be shared. When a request is received from a virtual machine to load a portion of a file that can be shared into memory, the virtual machine manager loads (if not previously loaded) the portion of the file into memory of the device and records a mapping from the location in virtual machine memory to the location in memory of the device where the portion is stored.

### BACKGROUND

As computing technology has advanced, various new techniques for using computers have evolved. One such technique is the use of virtual machines, where multiple virtual machines can be run on a single physical computing device. While virtual machines have many benefits, they are not without their problems. One such problem is that each virtual machine consumes resources on the computing device. This resource consumption can reduce the resources available to other virtual machines, thereby reducing the number of virtual machines that can be run on a computing device, which can lead to user dissatisfaction with their devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a request is received from a virtual machine running on a computing device to load a portion of a file from a storage device into a portion of memory of a virtual machine. A determination is made as to whether to share a portion of device memory storing the portion of the file in the computing device. In response to determining to share the portion of device memory, a mapping of the portion of memory of the virtual machine to the portion of device memory is recorded and an indication returned to the virtual machine that the portion of the file has been loaded into the portion of memory of the virtual machine. A read access is received from the virtual machine to read from the portion of memory of the virtual machine, and in response to the read access, the mapping is used to allow the virtual machine to read from the portion of the device memory.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a block diagram illustrating an example computing device implementing the memory sharing for virtual machines in accordance with one or more embodiments.

FIG. 2 illustrates an example of memory sharing for virtual machines in accordance with one or more embodiments.

FIG. 3 is a flowchart illustrating an example process for implementing memory sharing for virtual machines in accordance with one or more embodiments.

FIG. 4 illustrates an example system that includes an example computing device that is representative of one or more systems and/or devices that may implement the various techniques described herein.

### DETAILED DESCRIPTION

Memory sharing for virtual machines is discussed herein. A computing device runs one or more virtual machines, each having its own virtualized view of the computing device. A virtual machine manager manages starting and stopping virtual machines, and also coordinates access to physical resources of the computing device.

Each virtual machine has an associated virtual machine memory in which programs can be loaded and run. To run a program, an operating system of the virtual machine requests that at least a portion of a file that includes an executable for the program be loaded into the virtual machine memory. Situations can arise in which multiple virtual machines running on the computing device desire access to the same portion of the same file. For example, each virtual machine may be running the same word processing program and thus may request loading of the same executable file.

Using the techniques discussed herein, the virtual machine manager monitors requests from the virtual machines to load portions of files that can be shared. Various different criteria can be used to determine whether a portion of a file can be shared. When a request is received from a virtual machine to load a portion of a file into memory of the virtual machine, but the requested file portion can be shared, the virtual machine manager loads the portion of the file into memory of the computing device (if it has not been previously loaded into memory of the computing device), and records a mapping from the location in memory of the virtual machine that the virtual machine requested the file portion be loaded into to the location in memory of the computing device where the portion is stored. Thus, rather than loading the requested file into the requested location in the virtual machine's memory, the virtual machine manager updates a record to map the requested location in the virtual machine's memory to the location in the computing device memory where the file portion is stored. Subsequent accesses by the virtual machine to that location in the virtual machine's memory will be received by the virtual machine manager, the addresses will be updated to the mapped-to locations in the computing device's memory, and the accesses will proceed.

Thus, using the techniques discussed herein, portions of files that are used by multiple virtual machines can be stored in a single shared memory location and accessed by each of the multiple virtual machines. This reduces the amount of memory needed for each virtual machine (e.g., if there are eight virtual machines, the computing device need not keep eight copies of the same code in memory), thus increasing the number of virtual machines that can be implemented on the computing device. Furthermore, the shared memory locations are identified when requests to load file portions are made. The mapping of virtual machine memory locations to computing device memory locations is performed as part of the file portion loading process and thus need not consume resources to attempt to scavenge virtual machine memory in attempts to find portions of virtual machine memory storing the same data in each of multiple different virtual machines.

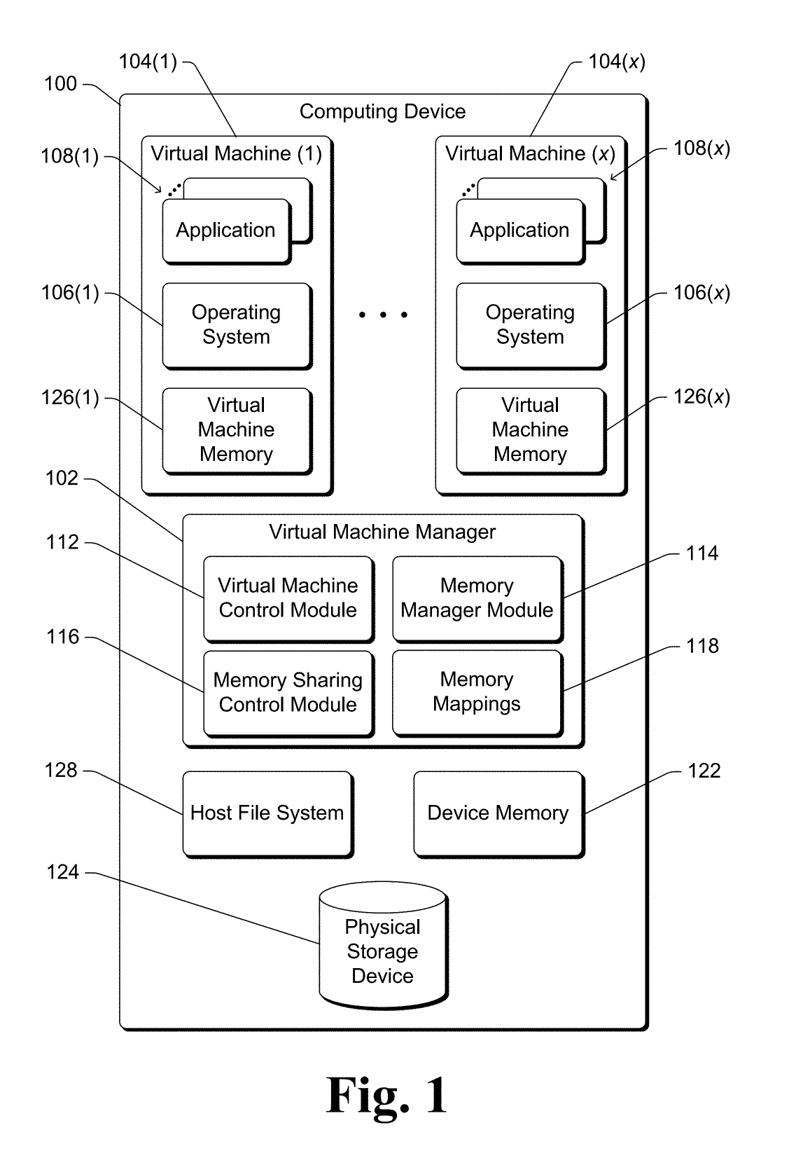

FIG. 1 is a block diagram illustrating an example computing device 100 implementing the memory sharing for virtual machines in accordance with one or more embodiments. The computing device 100 can be a variety of different types of devices. For example, the computing device 100 can be a desktop computer, a server computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet, augmented reality (AR) devices, virtual reality (VR) devices), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Thus, the computing device 100 may range from a full-resource device with substantial memory and processor resources (e.g., personal computers, game consoles) to a low-resource device with limited memory and/or processing resources (e.g., traditional set-top boxes, hand-held game consoles).

The computing device 100 includes a virtual machine manager 102 and multiple (x) virtual machines 104(1), . . . , 104(x). Although multiple virtual machines 104 are illustrated, it should be noted the computing device 100 can alternatively run only one virtual machine. Each virtual machine 104 is a logical unit of isolation within which an operating system 106 and one or more applications 108 runs. Each virtual machine 104 has its own virtualized view of the computing device 100, with the applications 108 and operating systems 106 interacting with virtualized resources of the computing device 100 (e.g., processors, memory, disks or other storage devices, network interface cards or other communication systems, etc.). Different virtual machines 104 can run the same or different operating systems 106, as well as the same or different applications 108. However, the operating systems 106 running within each virtual machine 104 are isolated from each other, and the applications 108 running within a virtual machine 104 are isolated from the applications 108 running in other virtual machines 104. The operating system 106 and applications 108 running in one virtual machine 104 are not able to access, and need not be aware of, the operating system 106 and applications 108 running in other virtual machines 104.

The virtual machine manager 102 manages the virtualization of resources of the computing device 100 for the virtual machines 104, providing access to the appropriate resources at the appropriate times. The virtual machine manager 102 can also be referred to as a hypervisor. The virtual machine manager 102 manages access to the functionality provided by components in the computing device 100. These components can be a variety of different physical components, such as processor components, input/output (I/O) components, and/or other components or devices. For example, the components can include one or more processors or processor cores, one or more memory components (e.g., volatile and/or nonvolatile memory), one or more storage devices (e.g., optical and/or magnetic disks, flash memory drives), one or more communication components (e.g., wired and/or wireless network adapters), combinations thereof, and so forth. These components are virtualized to the virtual machines 104, and access to these components is managed by the virtual machine manager 102.

The virtual machine manager 102 includes a virtual machine control module 112, a memory manager module 114, and a memory sharing control module 116. The virtual machine control module 112 manages the creation and deletion of virtual machines 104, creating and deleting virtual machines 104 as appropriate in response to various requests or other events in the computing device 100. The virtual machine control module 112 also manages interaction with physical components of the computing device 100, such as physical memory included in device memory 122 and a physical storage device 124. The physical storage device 124 can be any of a variety of different types of storage devices, such as magnetic disks, solid state disks, optical discs, storage-class memory (SCM) such as 3D Xpoint memory available from Intel Corporation of Santa Clara, Calif. or Micron Technology, Inc. of Boise, Id.

The device memory 122 includes physical memory, which can be any of a variety of different types of volatile or nonvolatile memory from which instructions can be executed, such as random access memory (RAM). The physical memory can also be storage-class memory. The device memory 122 can also implement virtual memory, providing a larger memory space than is available from physical memory alone and swapping pages of memory between physical memory and a page file (e.g., stored on the physical storage device 124).

The memory manager module 114 allocates to each virtual machine 104 virtual machine memory 126(1), . . . , 126(x). The operating system 106 within each virtual machine 104 manages the virtual machine memory 126 as if the virtual machine memory 126 were device memory. However, the memory manager module 114 maps the virtual machine memory 126 to device memory 122, so accesses to the virtual machine memory 126 are routed by the memory manager module 114 to the proper portions of device memory 122.

The memory sharing control module 116 manages memory sharing by the virtual machines 104. Memory sharing allows multiple different virtual machines 104 to be mapped to the same device memory portions 122 concurrently. Memory sharing is allowed when various criteria are satisfied, one criteria being that the portion of memory being shared stores the same content for each virtual machine 104 (e.g., each virtual machine 104 desires to execute instructions from the same executable file). For example, assume that multiple virtual machines 104 desire to read the same executable file (e.g., for a word processing program) from the physical storage device 124 and store that executable file into their virtual machine memory. The executable file can be read into a portion of device memory 122 and shared by each of the multiple virtual machines 104, allowing the portion of the executable file to be read and stored in memory once rather than having the file be read into the virtual machine memory of each of the multiple virtual machines 104.

In one or more embodiments, particular parts of device memory 122 are available for sharing by the virtual machines 104. These particular parts can be, for example, a file cache of the device memory 122. This file cache can be a file cache used by the host file system 128, although alternatively the file cache can be a cache of the virtual machine manager 102. Alternatively, there may be no restrictions on which parts of device memory 122 are available for sharing by the virtual machines 104.

During operation, a program of a virtual machine 104 issues a request to load a portion of a file (which may be part or all of the file) from a storage device into a portion of the virtual machine memory 126 of that virtual machine 104. The program can be one of the applications 108 of that virtual machine 104 or a program of an operating system 106 of that virtual machine 104. The operating system 106 receives the request from the program and issues to the file system of the virtual machine 104 a request to read the portion of the file into a portion of the virtual machine memory 126. The file system can be part of the operating system 106 or separate from the operating system 106. The read request is transferred over (e.g., by the file system or a storage device driver of the virtual machine 104) to the virtual machine manager 102.

The request to read the portion of the file identifies where in the virtual machine memory 126 of the virtual machine 104 the portion of the file is to be written. This portion of the virtual machine memory 126 can be, for example, a file cache in the virtual machine memory 126.

The virtual machine manager 102 receives the request to read the portion of the file and the memory sharing control module 116 determines whether to read the portion of the file from the physical storage device 124, and also determines whether to share a portion of the device memory 122 into which the portion of the file is written (also referred to as loaded) from the physical storage device 124. The memory sharing control module 116 determines to read the portion of the file from the physical storage device 124 if the portion of the file is not already stored in device memory 122 (e.g., not already stored in a file cache of the physical memory 122). Additionally, the memory sharing control module 116 can determine whether to share the portion of the device memory 122 into which the portion of the file is written based on various different criteria regarding the portion of the file as discussed in more detail below.

In response to determining to read the portion of the file from the physical storage device 124, the memory sharing control module 116 issues a read request to the host file system 128. The host file system 128 issues the appropriate requests (e.g., via a physical storage device driver) to read the desired portion from the file, and the contents of the desired portion of the file are written (e.g., by the physical storage device driver and/or the host file system 128) into a portion of the device memory 122 corresponding to the virtual machine 104 from which the request was received. This portion of the device memory 122 can be, for example, a portion of the physical memory 122 that is mapped to a file cache for the virtual machine 104. A completion response is returned from the host file system 128 to the memory sharing control module 116, which communicates the completion response to the file system of the virtual machine 104 and which is then returned to the program that made the read request. The program knows that the portion of the file has been read into the virtual machine memory 126 and can proceed to access the content of the portion of the file that is stored in the virtual machine memory 126 as desired (and optionally subject to permissions or approval from the operating system 106). The memory sharing control module 116 also maintains a record of the portion of the device memory 112 that the contents of the portion of the file were written into. Maintaining this record facilitates sharing the portion of the device memory 112 that the contents of the portion of the file were written into in the event a program of another virtual machine desires to read the portion of the file.

In response to determining to share the portion of the file, if the portion of the file has already been written into device memory 122 from the physical storage device 124, then the portion of the file need not be re-read from the physical storage device 124 and re-written into the device memory 122. However, if the portion of the file has not already been written into device memory 122 from the physical storage device 124, then the portion of the file is read from the physical storage device 124 and stored in the device memory 122. However, the portion of the file is stored in a portion of the device memory 122 that is shared memory rather than a portion of the device memory 122 corresponding to the virtual machine 104 from which the request was received.

If the portion of the file has previously been loaded (e.g., in response to a previous read request) into device memory 122 from the physical storage device 124, the memory sharing control module 116 notifies the memory manager module 114 of the portion of the device memory 122 that the portion of the file was written to when previously read from the physical storage device 124 (e.g., a portion of a file cache in the device memory 122). If the portion of the file is loaded into device memory 122 in response to the current read request, the memory sharing control module 116 notifies the memory manager module 114 of the portion of the device memory 122 into which the portion of the file was written. The memory manager module 114 records a record in memory mappings 118 that maps the portion of the virtual machine manager 126 into which the portion of the file was requested to be written to the portion of the device memory 122 into which the portion was written. The memory mappings 118 can take various forms, such as a table or other record.

A completion response is returned from the memory sharing control module 116 to the file system of the virtual machine 104, which is then returned to the program that made the read request. The program can proceed to access the content of the portion of the file that is stored as desired (and optionally subject to permissions or approval from the operating system 106). The virtual machine 104 believes that the portion of the file was written into the portion of its virtual machine memory 126 that was requested. So, on any subsequent read access to the memory by a program of the application 108 or operating system 106 (e.g., operation of a CPU read instruction), the read access to the virtual machine memory 126 is received by the virtual machine manager 102, the memory manager module 114 maps the read request to the portion of the device memory 122 into which the portion of the file were written (also referred to as shared memory), and returns the accessed data to the program.

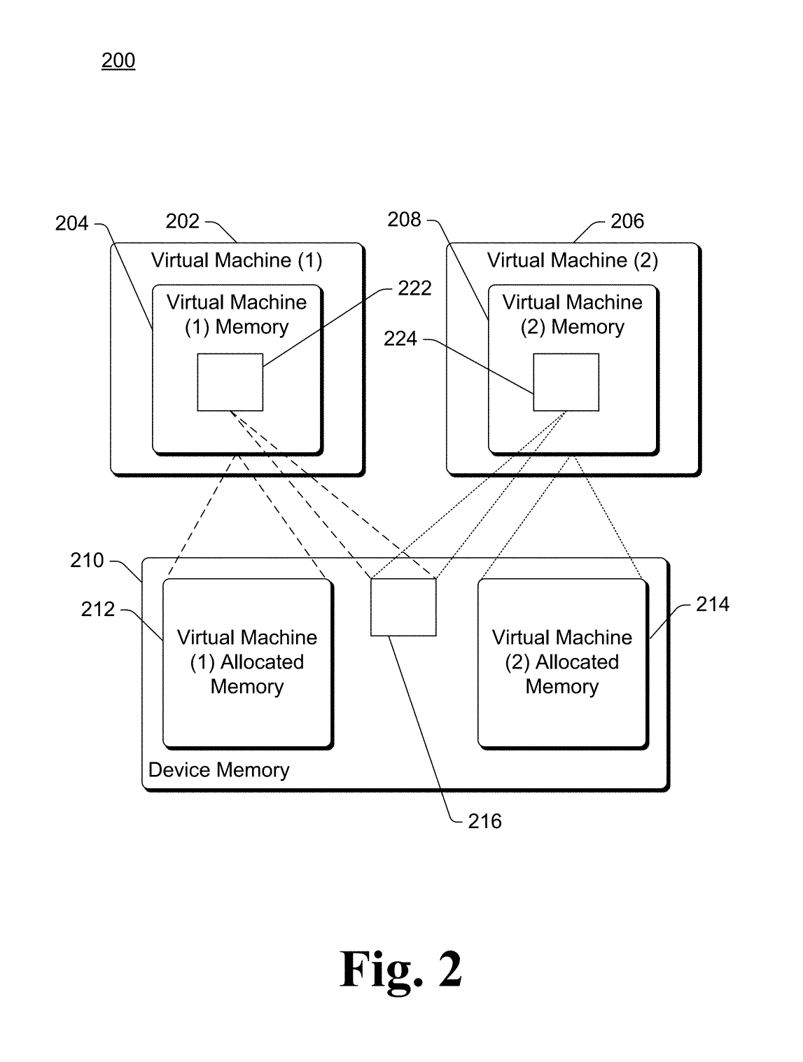

FIG. 2 illustrates an example 200 of memory sharing for virtual machines in accordance with one or more embodiments. In the example 200, a virtual machine 202 includes virtual machine memory 204 and a virtual machine 206 includes virtual machine memory 208. The virtual machines 202 and 206 can each be a virtual machine 104 of FIG. 1. The example 200 also includes a device memory 210, which can be the device memory 122 of FIG. 1.

A virtual machine manager (e.g., the virtual machine manager 102 of FIG. 1) allocates part of the device memory 210 to the virtual machine 202, shown as virtual machine allocated memory 212. The virtual machine manager also allocates part of the device memory 210 to the virtual machine 206, shown as virtual machine allocated memory 214.

A portion 216 of the device memory 210 is shared by the virtual machines 202 and 206. Portion 222 of the virtual machine memory 204 is mapped to the portion 216 of device memory 210, and portion 224 of the virtual machine memory 208 is mapped to the portion 216 of the device memory 210. These mappings are maintained by the virtual machine manager 102 of FIG. 1 (e.g., the memory manager module 114 of FIG. 1).

Thus, a portion of physical storage device can be written into the device memory 210 and shared by the two virtual machines 202 and 206. Each virtual machine 202 and 206 need not be allocated sufficient memory space to store copies of the portion 216, and instead the virtual machine manager can rely on the virtual machines 202 and 206 sharing this memory.

Returning to FIG. 1, it should be noted that the virtual machines 104 need not be aware of which portions of memory are being shared, or even that memory is being shared with other virtual machines. The sharing is managed by the virtual machine manager, and the mappings from the virtual machine memories 126 to the device memory 122 are managed by the memory manager module 114, so the virtual machines need have no knowledge of the mappings.

Furthermore, it should be noted that the mapping between device memory 122 and virtual machine memory does not need to be fixed permanently for a given mapping. For example, the device memory 122 being shared can be a cache (e.g., a file cache), and the virtual machine manager 102 or other component of the computing device 100 can apply its own eviction policies to the device memory 122 being shared. The virtual machines 104 do not need to know that the memory may be getting evicted. When a program of a virtual machine 104 tries to access the shared memory again, a new memory location of (a different portion of) device memory 122 can be used. The contents of the evicted memory are read into this new memory location, and the memory mappings 118 are updated to again associate the virtual machine memory with this new portion of device memory 122.

As mentioned above, the memory sharing control module 116 can determine whether to share a portion of the device memory 122 into which a portion of a file has been loaded based on various different criteria regarding the portion of the file. In one or more embodiments, the criteria includes particular files (e.g., as indicated by a particular file name or identifier), and the memory sharing control module 116 shares portions of the device memory 122 into which portions of particular files have been written. These particular files can be identified in various manners, such as pre-programmed into the memory sharing control module 116, provided to the memory sharing control module 116 by a user or administrator of the computing device 100, specified by policy applied to the computing device 100, obtained from a remote service or device, and so forth. For example, in one or more embodiments the virtual machine control module 112 creates a new virtual machine 104 in part by reading a template file (e.g., a virtual hard disk (VHD) file) that represents the contents of the virtual machine 104 into device memory 122. The contents of different virtual machines 104 can change as they are created and/or over time, so the virtual machine manager 102 maintains a record of these changes (e.g., in a differencing file). Each virtual machine 104 is created by reading at least a portion of the same template file, so the memory sharing control module 116 can have identified portions of the device memory 122 into which portions of the template file have been written as shared memory.

In one or more embodiments, the criteria used to determine whether to share a portion of the device memory 122 into which a portion of a file has been written includes an indication from the operating system 126. The memory sharing control module 116 receives an indication from the operating system 126 of files that, after a portion of the file is written into the device memory 122, the portion of the device memory 122 is shared memory. This indication can take various forms, such as a flag, parameter, or other hint included in a request to read a portion of a file. The operating system 126 can use various different rules, algorithms, and so forth to determine which files (or which portions of files) it provides the indication for. For example, the operating system 126 can provide the indication for files that the operating system 126 is opening as read-only, for files going into a file cache of the virtual machine 104, and so forth.

In one or more embodiments, the criteria used to determine whether to share a portion of the device memory 122 into which a portion of a file has been written includes the particular storage device location being read from. Certain locations of the storage device are deemed to store portions of files that are more likely to be read by programs from multiple virtual machines than other locations, and the memory into which portions of the file at those locations of the storage device is written is determined to be shared memory. These locations can be aligned along certain values, such as the smallest page size supported by the computing device 100 (e.g., 4 kilobytes (4 k)). So, for example, a read from a portion of the storage device that is 4 k aligned is determined to be written into a portion of the device memory 122 that is shared memory, but a read from a portion of the storage device that is not 4 k aligned is determined to be written into a portion of the device memory 122 that is not shared memory.

In one or more embodiments, the criteria used to determine whether to share a portion of the device memory 122 into which a portion of a file has been written includes expected use information regarding which files are deemed likely to be used in a read-only manner. The memory into which portions of files deemed likely to be used in a read-only manner is determined to be shared memory. This expected use information can be provided by, for example, a user or administrator of the computing device 100, an external service or device, and so forth. This expected use information can also be generated by the computing device 100 itself. For example, the virtual machine manager 102 can monitor which files are read from but not written to during operation of the computing device 100, and after a threshold number (e.g., 5 or 10) of read accesses to the file but no write accesses to the file, the virtual machine manager 102 can record expected use information indicating that portions of the file are deemed likely to be used in a read-only manner.

In one or more embodiments, the criteria used to determine whether to share a portion of the device memory 122 into which a portion of a file has been written includes expected use information regarding which files are deemed likely to be written to. The memory into which portions of files deemed likely to be written to is determined to not be shared memory, and the memory into which portions of other files (those that are not deemed likely to be written to) are determined to be shared memory. This expected use information can be provided by, for example, a user or administrator of the computing device 100, an external service or device, and so forth. This expected use information can also be generated by the computing device 100 itself. For example, the virtual machine manager 102 can monitor which files are written to during operation of the computing device 100, and after a threshold number (e.g., 1 or 3) of write accesses to the file, the virtual machine manager 102 can record expected use information indicating that portions of the file are deemed likely to be written to.

Expected use information, whether it be information regarding which files are deemed likely to be used in a read-only manner or information regarding which files are deemed likely to be written to, can also be shared among computing devices. This information can be crowd sourced and stored at a service, or multiple computing devices can alternatively directly communicate the information to others of the multiple computing devices. For example, multiple computing devices analogous to computing device 100 can record expected use information and communicate that expected use information to others of the multiple computing devices or to a service. Each of the multiple computing devices can access this information and use it to determine whether to share a portion of the device memory 122 into which a portion of a file has been written.

Portions of the virtual machine memory of multiple virtual machines are mapped to the same shared memory (the same portion of device memory 122) as discussed above. If a program running in a virtual machine attempts to write to the portion of shared memory, such write accesses are received by the virtual machine manager 102 and the virtual machine manager 102 (e.g., the memory manager module 114) detects based on the memory mappings 118 that the write is to a portion of the physical memory that is shared memory. In response to such a write access, the memory sharing control module 116 ceases sharing at least part of that portion of physical memory for the virtual machine 104 from which the write access was received. However, sharing of that portion of physical memory for other virtual machines 104 (virtual machines 104 from which write accesses to the portion of physical memory were not received) continues. In one or more embodiments, the memory sharing control module 116 ceases sharing one or more memory pages of the portion of physical memory (e.g., all of the memory pages of the portion of physical memory, or one or more memory pages to which the write attempt was directed). The memory sharing control module 116 ceases sharing one or more memory pages of physical memory by copying the contents of the one or more memory pages into the virtual machine memory 126 of the virtual machine 104 from which the write access was received, and having the memory manager module 114 update the memory mappings 118 to reflect that those one or more memory pages are no longer mapped to the portion of the physical memory that is shared memory (e.g., by deleting a record of mappings for those one or more memory pages that was previously added to the memory mappings 118). Thus, in response to a write access to a portion of physical memory that is shared memory, the virtual machine memory 126 of the virtual machine 104 from which the write access was received is no longer mapped to the portion of physical memory that is shared memory.

It should be noted that the memory sharing control module 116 ceasing sharing a memory page of the portion of physical memory can be part of the criteria used to determine whether to share a portion of the device memory 122 into which a portion of a file has been written at a later time (e.g., for another virtual machine that access the portion of the file, or when the computing device 100 is later restarted). The information regarding ceasing sharing a memory page of the portion of physical memory can be expected use information regarding which files are deemed likely to be written to. For example, if one or more memory pages of a portion of a file written into memory cease to be shared, the virtual machine manager 102 can record expected use information indicating that portions of that file are deemed likely to be written to.

By having multiple virtual machines share memory in the computing device, the amount of memory that is allocated to each virtual machine can be reduced. For example, if a virtual machine is typically allocated 4 gigabytes (GB) of memory, but 1 GB of the memory used by the virtual machine can be shared memory, then the amount of memory allocated to the virtual machine can be reduced to 3 GB. This reduces the resource (e.g., memory) usage of the virtual machine, and allows an increase in virtual machine density on the computing device 100 (e.g., increases the number of virtual machines that can be run on the computing device 100).

Furthermore, by having multiple virtual machines share memory in the computing device, the number of storage device reads that are performed is reduced. This can improve performance of the computing device (e.g., because memory reads are typically faster than disk or other storage device reads). Furthermore, this reduces wear and tear on the storage device.

It should be noted that the techniques discussed herein manage sharing memory at the time that read requests are made to the physical storage device 124. Scavenging of memory used by different virtual machines in an attempt to identify memory pages of the different virtual machines that store the same content need not be performed because the determination is made when the read requests to the physical storage device 124 are received by the virtual machine manager.

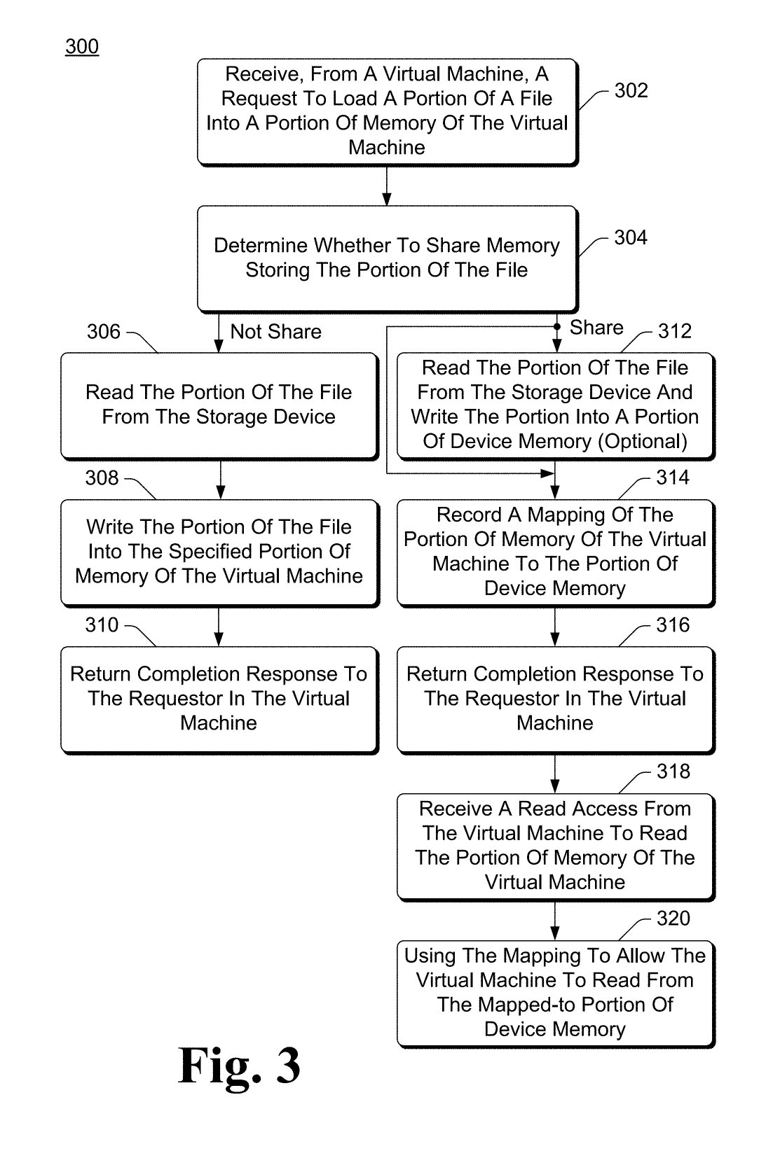

FIG. 3 is a flowchart illustrating an example process 300 for implementing memory sharing for virtual machines in accordance with one or more embodiments. Process 300 is carried out by a virtual machine manager, such as virtual machine manager 102 of FIG. 1, and can be implemented in software, firmware, hardware, or combinations thereof. Process 300 is shown as a set of acts and is not limited to the order shown for performing the operations of the various acts. Process 300 is an example process for implementing memory sharing for virtual machines; additional discussions of implementing memory sharing for virtual machines are included herein with reference to different figures.

In process 300, a request to load a portion of a file into a portion of memory of the virtual machine is received from a virtual machine (act 302). The request originates from a program in the virtual machine, such as an application program or operating system program running in the virtual machine. The request can be, for example, a request to load the portion of the file into a file cache in the memory of the virtual machine.

A determination is made as to whether to share memory storing the portion of the file (act 304). This determination can be made on various different criteria regarding the file, as discussed above.

In response to a determination to not share the portion of the file, the portion of the file is read from the physical storage device (act 306) and written into a portion of memory of a virtual machine (act 308). The portion of virtual memory is specified as part of the request received in act 302. A completion response is returned to the requester in the virtual machine (act 310). The requester is, for example, the program that originated the request in act 302. The requester can then proceed to access the portion of the file from the memory of the virtual machine.

In response to a determination to share the portion of the file, if the portion of the file was not previously written into a portion of device memory, then the portion of the file is read from the physical storage device and written into a portion of device memory (act 312). However, if the portion of the file was previously written into a portion of device memory, then the portion of the file need not be re-read and re-written in act 312. Accordingly, act 312 is optional.

A mapping of the portion of memory of the virtual machine to the portion of device memory is maintained (act 314). The portion of memory of the virtual machine is the portion into which the portion of the file was requested to be loaded, and the portion of device memory is the portion of the device memory into which the portion of the file was written (in act 312 or previously).

A completion response is returned to the requester in the virtual machine (act 310). The completion response indicates to the requester that the portion of the file has been written into the requested portion of memory of the virtual machine.

A read access is received from the virtual machine to read the portion of memory of the virtual machine (act 318). This portion of memory of the virtual machine is the same portion as was indicated by the request received in act 302.

In response to the read access, the mapping recorded in act 314 is used to allow the virtual machine to read from the mapped-to portion of device memory (act 320). Thus, rather than reading from the portion of the virtual machine, the mapped-to portion of the device memory is read from and the read content of the portion is returned to the program making the read request.

In the discussions herein, reference is made to the device memory 122 and the physical storage device 124 of the computing device 100. However, it should be noted that in some situations a single type of memory is used as both the physical memory included as part of the device memory 122 and the physical storage device 124. For example, storage-class memory discussed above can be used as both the physical memory and the physical storage device 124. In such situations, rather than reading a portion of a file into the device memory 122 and sharing that portion of the device memory 122, the portion of the file itself can be shared. E.g., the memory manager module 114 can map a portion of the virtual machine memory 126 of a virtual machine 104 to the portion of the file in the storage-class memory.

Additionally, as discussed above the virtual machines 104 and the operating systems 106 in the virtual machines need have no knowledge of the shared memory in the device memory 122. Thus, the techniques discussed herein can be used with multiple different types of operating systems and the operating systems need not be configured in any special manner to use the techniques discussed herein. Alternatively, one or more operating systems 106 may be designed or compiled to facilitate use with the techniques discussed herein. For example, fixups performed on code when loaded into device memory 122 (e.g., updating an address based on where the code is loaded into device memory 122) can be performed. By reducing the number of such fixups that are performed, the amount of memory that remains read-only and thus can be shared with other virtual machines is increased.

By way of another example, as discussed above situations can arise in which a program of a virtual machine 104 writes to a memory page in a portion of shared memory. In such situations, the memory sharing control module 116 ceases sharing the memory page for the virtual machine 104. The operating system 106 can determine when a portion (e.g., multiple memory pages) of the virtual machine memory 126 is to be written to or available to be written to (e.g., the memory pages used by a file that is no longer being used by the virtual machine 104) and notify the virtual machine manager 102 of the portion of the virtual machine manager 126 that is to be written to or available to be written to. The multiple memory pages included in that portion are likely to no longer be read-only, and the memory sharing control module 116 can cease sharing the multiple memory pages for the virtual machine 104, managing this ceasing for the multiple memory pages concurrently. Thus, rather than being invoked each time sharing of a memory page is to cease, the memory sharing control module 116 can be invoked once and handle the ceasing of sharing of the multiple memory pages for the virtual machine 104 together.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

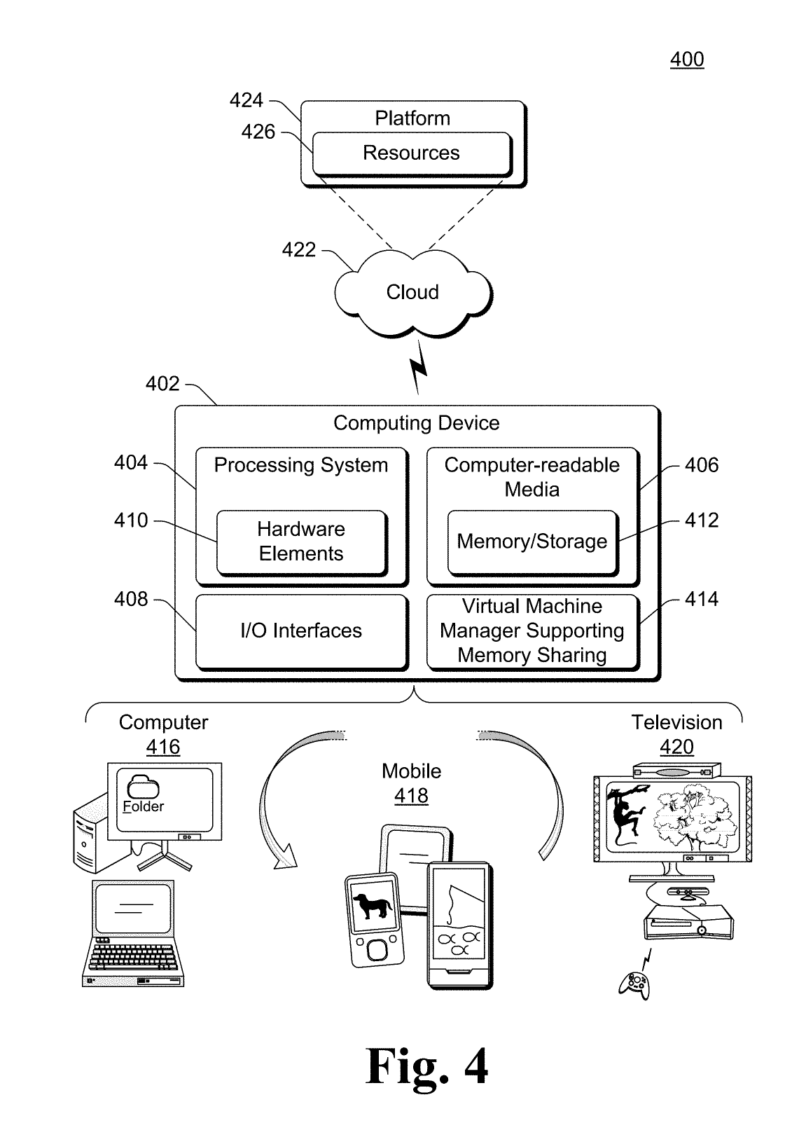

FIG. 4 illustrates an example system generally at 400 that includes an example computing device 402 that is representative of one or more systems and/or devices that may implement the various techniques described herein. The computing device 402 may be, for example, a server of a service provider, a device associated with a client (e.g., a client device), an on-chip system, and/or any other suitable computing device or computing system.

The example computing device 402 as illustrated includes a processing system 404, one or more computer-readable media 406, and one or more I/O Interfaces 408 that are communicatively coupled, one to another. Although not shown, the computing device 402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 404 is representative of functionality to perform one or more operations using hardware. Accordingly, the processing system 404 is illustrated as including hardware elements 410 that may be configured as processors, functional blocks, and so forth. This may include implementation in hardware as an application specific integrated circuit or other logic device formed using one or more semiconductors. The hardware elements 410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 406 is illustrated as including memory/storage 412. The memory/storage 412 represents memory/storage capacity associated with one or more computer-readable media. The memory/storage 412 may include volatile media (such as random access memory (RAM)) and/or nonvolatile media (such as read only memory (ROM), Resistive RAM (ReRAM), Flash memory, optical disks, magnetic disks, and so forth). The memory/storage 412 may include fixed media (e.g., RAM, ROM, a fixed hard drive, and so on) as well as removable media (e.g., Flash memory, a removable hard drive, an optical disc, and so forth). The computer-readable media 406 may be configured in a variety of other ways as further described below.

The one or more input/output interface(s) 408 are representative of functionality to allow a user to enter commands and information to computing device 402, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 402 may be configured in a variety of ways as further described below to support user interaction.

The computing device 402 also includes a virtual machine manager supporting memory sharing 414. The virtual machine manager supporting memory sharing 414 provides various memory sharing functionality to virtual machines running on the computing device 402 as discussed above. The virtual machine manager supporting memory sharing 414 can implement, for example, the virtual machine manager 102 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 402. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 402, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 410 and computer-readable media 406 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 410. The computing device 402 may be configured to implement particular instructions and/or functions corresponding to the software and/or hardware modules. Accordingly, implementation of modules as a module that is executable by the computing device 402 as software may be achieved at least partially in hardware, e.g., through use of computer-readable storage media and/or hardware elements 410 of the processing system. The instructions and/or functions may be executable/operable by one or more articles of manufacture (for example, one or more computing devices 402 and/or processing systems 404) to implement techniques, modules, and examples described herein.

As further illustrated in FIG. 4, the example system 400 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 400, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 402 may assume a variety of different configurations, such as for computer 416, mobile 418, and television 420 uses. Each of these configurations includes devices that may have generally different constructs and capabilities, and thus the computing device 402 may be configured according to one or more of the different device classes. For instance, the computing device 402 may be implemented as the computer 416 class of a device that includes a personal computer, desktop computer, a multi-screen computer, laptop computer, netbook, and so on.

The computing device 402 may also be implemented as the mobile 418 class of device that includes mobile devices, such as a mobile phone, portable music player, portable gaming device, a tablet computer, a multi-screen computer, and so on. The computing device 402 may also be implemented as the television 420 class of device that includes devices having or connected to generally larger screens in casual viewing environments. These devices include televisions, set-top boxes, gaming consoles, and so on.

The techniques described herein may be supported by these various configurations of the computing device 402 and are not limited to the specific examples of the techniques described herein. This functionality may also be implemented all or in part through use of a distributed system, such as over a “cloud” 422 via a platform 424 as described below.

The cloud 422 includes and/or is representative of a platform 424 for resources 426. The platform 424 abstracts underlying functionality of hardware (e.g., servers) and software resources of the cloud 422. The resources 426 may include applications and/or data that can be utilized while computer processing is executed on servers that are remote from the computing device 402. Resources 426 can also include services provided over the Internet and/or through a subscriber network, such as a cellular or Wi-Fi network.

The platform 424 may abstract resources and functions to connect the computing device 402 with other computing devices. The platform 424 may also serve to abstract scaling of resources to provide a corresponding level of scale to encountered demand for the resources 426 that are implemented via the platform 424. Accordingly, in an interconnected device embodiment, implementation of functionality described herein may be distributed throughout the system 400. For example, the functionality may be implemented in part on the computing device 402 as well as via the platform 424 that abstracts the functionality of the cloud 422.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method implemented on a computing device, the method comprising: receiving, from a virtual machine running on the computing device, a request to load a portion of a file from a storage device into a portion of memory of the virtual machine; determining whether to share a portion of device memory storing the portion of the file in the computing device; recording, in response to determining to share the portion of device memory, a mapping of the portion of memory of the virtual machine to the portion of device memory; returning an indication to the virtual machine that the portion of the file has been loaded into the portion of memory of the virtual machine; receiving a read access from the virtual machine to read from the portion of memory of the virtual machine; and using, in response to the read access, the mapping to allow the virtual machine to read from the portion of the device memory.

Alternatively or in addition to any of the methods or devices described herein, any one or combination of: the device memory comprising a file cache of the computing device; further comprising receiving a write access from the virtual machine to write to the portion of memory of the virtual machine, and in response to the write access, copying one or more memory pages of the portion of device memory to the memory of the virtual machine and ceasing sharing the one or more memory pages of the portion of device memory for the virtual machine; further comprising repeating, for each of one or more additional virtual machines running on the computing device, the receiving a request to load the portion of the file, the determining whether to share a portion of device memory storing the portion of the file, the recording a mapping, and the returning an indication; the virtual machine having no knowledge that the portion of memory of the virtual machine was mapped to the portion of device memory; the determining whether to share the portion of device memory including determining to share the portion of device memory storing in response to the portion of the file being at a location on the storage device aligned along a particular value; the determining whether to share the portion of device memory including determining to share the portion of device memory in response to receiving an indication from an operating system running in the virtual machine to share memory storing the portion of the file; the determining whether to share the portion of device memory including determining to share the portion of device memory in response to the file being a file deemed likely to be used in a read-only manner; the determining whether to share the portion of device memory including determining to share the portion of device memory in response to determining that the file was not previously written to by the virtual machine; the storage device comprising a storage-class memory device; the portion of device memory and the portion of the file comprising a same portion of the storage-class memory device, and the recording a mapping comprising recording a mapping of the portion of memory of the virtual machine to the portion of the storage-class memory device; further comprising receiving an indication that a set of multiple pages of the memory of the virtual machine is to be written to, the set of multiple pages including the portion of memory of the virtual machine, and deleting the recorded mapping of the portion.

A computing device comprising: a physical storage device; a device memory; a virtual machine manager configured to: receive, from a virtual machine running on the computing device, a request to load a portion of a file from the storage device into a portion of memory of the virtual machine; determine whether to share a portion of the device memory storing the portion of the file in the computing device; record, in response to determining to share the portion of the device memory, a mapping of the portion of memory of the virtual machine to the portion of the device memory; return an indication to the virtual machine that the portion of the file has been loaded into the portion of memory of the virtual machine; receive a read access from the virtual machine to read from the portion of memory of the virtual machine; and use, in response to the read access, the mapping to allow the virtual machine to read from the portion of the device memory.

Alternatively or in addition to any of the methods or devices described herein, any one or combination of: wherein to determine whether to share the portion of the device memory is to determine to share the portion of the device memory in response to the file being a file deemed likely to be used in a read-only manner; the portion of the device memory and the portion of the file comprising a same portion of a storage-class memory device, and wherein to record a mapping is to record a mapping of the portion of memory of the virtual machine to the portion of the storage-class memory device.

A computing device comprising: one or more processors; and a computer-readable storage medium having stored thereon multiple instructions that, responsive to execution by the one or more processors, cause the one or more processors to: receive, from a virtual machine running on the computing device, a request to load a portion of a file from a storage device into a portion of memory of the virtual machine; determine whether to share a portion of device memory storing the portion of the file in the computing device; record, in response to determining to share the portion of device memory, a mapping of the portion of memory of the virtual machine to the portion of device memory; return an indication to the virtual machine that the portion of the file has been loaded into the portion of memory of the virtual machine; receive a read access from the virtual machine to read from the portion of memory of the virtual machine; and use, in response to the read access, the mapping to allow the virtual machine to read from the portion of the device memory.

Alternatively or in addition to any of the methods or devices described herein, any one or combination of: the portion of device memory and the portion of the file comprising a same portion of a storage-class memory device, and wherein to record a mapping is to record a mapping of the portion of memory of the virtual machine to the portion of the storage-class memory device; the virtual machine having no knowledge that the portion of memory of the virtual machine was mapped to the portion of device memory; wherein to determine whether to share the portion of device memory is to determine to share the portion of device memory in response to receiving an indication from an operating system running in the virtual machine to share memory storing the portion of the file; wherein to determine whether to share the portion of device memory is to share the portion of device memory in response to determining that the file was not previously written to by the virtual machine.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented on a computing device, the method comprising:
receiving, from a virtual machine running on the computing device, a request to load a portion of a file from a storage device into a portion of memory of the virtual machine;
determining whether to share a portion of device memory storing the portion of the file in the computing device;
recording, in response to determining to share the portion of device memory, a mapping of the portion of memory of the virtual machine to the portion of device memory;
returning an indication to the virtual machine that the portion of the file has been loaded into the portion of memory of the virtual machine;
receiving a read access from the virtual machine to read from the portion of memory of the virtual machine; and
using, in response to the read access, the mapping to allow the virtual machine to read from the portion of the device memory.

2. The method as recited in claim 1, the device memory comprising a file cache of the computing device.

3. The method as recited in claim 1, further comprising:
receiving a write access from the virtual machine to write to the portion of memory of the virtual machine; and
in response to the write access, copying one or more memory pages of the portion of device memory to the memory of the virtual machine and ceasing sharing the one or more memory pages of the portion of device memory for the virtual machine.

4. The method as recited in claim 1, further comprising repeating, for each of one or more additional virtual machines running on the computing device, the receiving a request to load the portion of the file, the determining whether to share a portion of device memory storing the portion of the file, the recording a mapping, and the returning an indication.

5. The method as recited in claim 1, the virtual machine having no knowledge that the portion of memory of the virtual machine was mapped to the portion of device memory.

6. The method as recited in claim 1, the determining whether to share the portion of device memory including determining to share the portion of device memory storing in response to the portion of the file being at a location on the storage device aligned along a particular value.

7. The method as recited in claim 1, the determining whether to share the portion of device memory including determining to share the portion of device memory in response to receiving an indication from an operating system running in the virtual machine to share memory storing the portion of the file.

8. The method as recited in claim 1, the determining whether to share the portion of device memory including determining to share the portion of device memory in response to the file being a file deemed likely to be used in a read-only manner.

9. The method as recited in claim 1, the determining whether to share the portion of device memory including determining to share the portion of device memory in response to determining that the file was not previously written to by the virtual machine.

10. The method as recited in claim 1, the storage device comprising a storage-class memory device.

11. The method as recited in claim 10, the portion of device memory and the portion of the file comprising a same portion of the storage-class memory device, and the recording a mapping comprising recording a mapping of the portion of memory of the virtual machine to the portion of the storage-class memory device.

12. The method as recited in claim 1, further comprising receiving an indication that a set of multiple pages of the memory of the virtual machine is to be written to, the set of multiple pages including the portion of memory of the virtual machine, and deleting the recorded mapping of the portion.

13. A computing device comprising:
a physical storage device;
a device memory;
a virtual machine manager configured to:
receive, from a virtual machine running on the computing device, a request to load a portion of a file from the storage device into a portion of memory of the virtual machine;
determine whether to share a portion of the device memory storing the portion of the file in the computing device;
record, in response to determining to share the portion of the device memory, a mapping of the portion of memory of the virtual machine to the portion of the device memory;
return an indication to the virtual machine that the portion of the file has been loaded into the portion of memory of the virtual machine;
receive a read access from the virtual machine to read from the portion of memory of the virtual machine; and
use, in response to the read access, the mapping to allow the virtual machine to read from the portion of the device memory.

14. The computing device as recited in claim 13, wherein to determine whether to share the portion of the device memory is to determine to share the portion of the device memory in response to the file being a file deemed likely to be used in a read-only manner.

15. The computing device as recited in claim 13, the portion of the device memory and the portion of the file comprising a same portion of a storage-class memory device, and wherein to record a mapping is to record a mapping of the portion of memory of the virtual machine to the portion of the storage-class memory device.

16. A computing device comprising:
one or more processors; and
a computer-readable storage medium having stored thereon multiple instructions that, responsive to execution by the one or more processors, cause the one or more processors to:
receive, from a virtual machine running on the computing device, a request to load a portion of a file from a storage device into a portion of memory of the virtual machine;
determine whether to share a portion of device memory storing the portion of the file in the computing device;
record, in response to determining to share the portion of device memory, a mapping of the portion of memory of the virtual machine to the portion of device memory;
return an indication to the virtual machine that the portion of the file has been loaded into the portion of memory of the virtual machine;
receive a read access from the virtual machine to read from the portion of memory of the virtual machine; and
use, in response to the read access, the mapping to allow the virtual machine to read from the portion of the device memory.

17. The computing device as recited in claim 16, the portion of device memory and the portion of the file comprising a same portion of a storage-class memory device, and wherein to record a mapping is to record a mapping of the portion of memory of the virtual machine to the portion of the storage-class memory device.

18. The computing device as recited in claim 16, the virtual machine having no knowledge that the portion of memory of the virtual machine was mapped to the portion of device memory.

19. The computing device as recited in claim 16, wherein to determine whether to share the portion of device memory is to determine to share the portion of device memory in response to receiving an indication from an operating system running in the virtual machine to share memory storing the portion of the file.

20. The computing device as recited in claim 16, wherein to determine whether to share the portion of device memory is to share the portion of device memory in response to determining that the file was not previously written to by the virtual machine.
